(19) United States
(12) Patent Application Publication
(10) Pub. No.: US 2016/0272091 A1
(43) Pub. Date: Sep. 22, 2016

(54) PRIMARY FORMED PART FOR TRANSMITTING OPERATING TORQUES

(71) Applicant: GM GLOBAL TECHNOLOGY OPERATIONS LLC, Detroit, MI (US)

(72) Inventors: Christian KUHLEY, Ruesselsheim (DE); Felix SOMMERFELD, Ruesselsheim (DE)

(73) Assignee: GM GLOBAL TECHNOLOGY OPERATIONS LLC, Detroit, MI (US)

(21) Appl. No.: 15/071,492

(22) Filed: Mar. 16, 2016

(30) Foreign Application Priority Data
Mar. 16, 2015 (DE) 102015003311.5

(51) Int. Cl. B60N 2/44; F16H 55/08; G05G 1/04

(52) U.S. Cl. CPC B60N 2/44; G05G 1/04; F16H 55/08

(57) ABSTRACT

A primary formed part for transmitting operating torques is disclosed. The primary formed part has a helical structure featuring at least one helical profile with a helix that spirals around a screw axis.

### CROSS-REFERENCE TO RELATED APPLICATION

This application claims priority to German Patent Application No, 102015003311.5, filed Mar. 16, 2015, which is incorporated herein by reference in its entirety.

### TECHNICAL FIELD

The present disclosure pertains to a primary formed part for transmitting operating torques, a motor vehicle component arrangement with the primary formed part, as well as a method for manufacturing the primary formed part.

### BACKGROUND

DE 42 15 725 A1 discloses a clutch for connecting two shafts in a torque-proof fashion. The clutch features a plastic injection-molded coupling link that is composed of a plurality of axially spaced-apart disks arranged parallel to one another and transverse to the coupling link axis, The disks are connected to one another by means of axial webs that are offset relative to one another by the same angles at circumference.

### SUMMARY

The present disclosure improves a motor vehicle component arrangement and a primary formed part for transmitting operating torques and/or its manufacture. In particular, a primary formed part or primary⁻ formed component has a helical structure with at least one helical profile, The helical profile, particularly its surface, follows at least one helix spiraling around a screw axis, particularly the helix spiraling around the screw axis. The helical structure advantageously makes it possible to respectively make available and manufacture a primary-formable, lightweight, compact and/or torsion-proof component, particularly a motor vehicle component for advantageously transmitting operating torques.

According to an aspect of the present disclosure, a motor vehicle component arrangement for transmitting operating torques, particularly an adjusting mechanism, especially a seat adjusting mechanism, or a drive arrangement, particularly a drivetrain arrangement, therefore may feature a primary formed part described herein. The motor vehicle component, particularly an adjusting mechanism, especially a seat adjusting mechanism, or a drivetrain arrangement, includes a primary formed part described herein,

According to an aspect of the present disclosure, a primary formed part described herein accordingly is used in a motor vehicle component arrangement, particularly as a motor vehicle component for transmitting operating torques in an adjusting mechanism, especially a seat adjusting mechanism, or in a drive arrangement, particularly a drivetrain arrangement.

According to another aspect of the present disclosure, primary-formable starting material, particularly liquid, plastic or doughy or pasty or pulpy starting material, is pressed through a die, particularly extruded, in order to manufacture a primary formed part described herein. The primary formed part therefore may consist, in particular, of an extruded part. In another embodiment, moldable starting material, in the form of a liquid, plastic or doughy or pasty or pulpy starting material, is filled, particularly injected, into a mold that can be opened in order to manufacture a primary formed part described herein. The primary formed part therefore may consist, in particular, of an injection-molded part. In an embodiment, the slide-free mold is opened in a removal direction perpendicular to the screw axis in a mold parting plane, in which the screw axis lies.

In the present context, the term operating torques particularly refers to torques that may occur during the operation of the formed part or motor vehicle component or torques, for the transmission of which the formed part or motor vehicle component is intended or designed or used, particularly torques for transmitting an adjustment or control actuation and/or a driving torque, In an embodiment, the operating torques are time-variant during the operation, particularly in such a way that they intermittently disappear and/or increase and/or alternate, and therefore can be distinguished, in particular, from a tightening torque of a connecting or fastening screw. Accordingly, a formed part or motor vehicle component described herein is in an embodiment not a connecting or fastening screw or is in an embodiment not used or intended as a frictional connecting or fastening element.

A helical profile of the helical structure, particularly a helical profile in the form of a screw or endless screw or spiral, can be respectively defined or thematically) created or generated, in particular, by spiraling a cross-sectional profile, which is constant or varies along the screw axis, around the screw axis. In the present context, spiraling of a cross-sectional profile refers to a twist of the cross-sectional profile around the screw axis and a simultaneous or superimposed displacement in the direction of the screw axis as it is generally known from helicoids. If u(t)=[x(t), y(t), z(t)]^{T}, t₁≦t≦t₂ designates the edge of the cross-sectional profile in an embodiment, then V(t,φ)=[x(t)cos(φ) −y(t)·sin(φ), x(t)·sin(φ) +y(t)·cos(φ), z(t) +c·φ]^{T}, t₁≦t≦t₂, φ₁≦φ≦φ₂≧360°+φ₁ designates the edge of the helical profile in an embodiment.

The surface of a helical profile of the helical structure, particularly a helical profile in the form of a screw or endless screw or spiral, can be respectively defined or (mathematically) created or generated, in particular, by (a multitude of) helices spiraling around the screw axis. A helix [x, y, z]^{T} can be respectively described or defined, in particular, in the form of [x, y, z]^{T}=[r·cos(φ), r·sin(φ), c·φ]^{T}, φ₁≦φ≦φ₂≧360°+φ₁.

In an embodiment, at least one helix of at least one helical profile or its spiraling extent has a constant pitch or screw parameter =constant) or a varying pitch or screw parameter (c=c(z)) at least over sections of the screw axis.

At least one helical profile therefore may, in particular, include a screw, an endless screw or a spiral.

In an embodiment, the helical structure features two or more equi-directional helical profiles that are offset relative to one another in the direction of the screw axis and have the same spiraling direction. The helical structure may particularly feature two or more equi-directional helical profiles that are offset relative to one another in the direction of the (screw) axis and may be respectively defined or (mathematically) generated by equi-directionally spiraling said helical profiles or different cross-sectional profiles around the screw axis. The helical structure therefore may be double-threaded or multiple-threaded, wherein two equi-directional helical profiles are offset relative to one another in the direction of the (screw) axis by half the pitch.

In an embodiment, the torsional rigidity or the value of the transmittable operating torques can thereby be advantageously increased.

The helical structure additionally or alternatively features two or more oppositely directed helical profiles that respectively have different or opposite spiraling directions. The helical structure particularly may feature two or more oppositely directed helical profiles that are respectively defined or mathematically generated by spiraling the helical profiles or different cross-sectional profiles around the screw axis in opposite directions.

In an embodiment, the torsional rigidity in opposite rotating directions or the value of transmittable, oppositely directed operating torques can thereby be advantageously increased.

In an embodiment, the cross-sectional profile of one or more helical profiles of the helical arrangement, the spiraling of which respectively generates or defines the helical profile, respectively has two opposite sides, wherein one of these sides is curved and the opposite side is straight, Additionally or alternatively, the cross-sectional profile of one or more helical profiles of the helical arrangement respectively has two opposite sides, wherein both sides are curved. Additionally or alternatively, the cross-sectional profiles of one or more helical profiles of the helical arrangement respectively have two opposite sides, wherein both sides are straight. In other words, one or more helical profiles of the helical arrangement may be respectively defined or delimited by so-called ruled helicoids on one or both sides.

In an embodiment, the wall thickness of one or more helical profiles of the helical arrangement is at least essentially constant toward the screw axis. The cross-sectional profile of one or more helical profiles of the helical arrangement generating or defining the helical profile particularly may have parallel sides.

In an embodiment, a primary-formable, lightweight, compact and/or torsion-proof component can thereby be made available and advantageously manufactured.

The wall thickness of one or more helical profiles of the helical arrangement may additionally or alternatively converge or diverge toward the screw axis. The cross-sectional profile of one or more helical profiles of the helical arrangement generating or defining the helical profile particularly may have sides that converge or diverge toward the screw axis.

in an embodiment, a converging wall thickness toward the screw axis advantageously makes it possible to arrange material distant from the screw axis such that the polar geometric moment of inertia and therefore the torsional rigidity can be further increased. In an embodiment, a primary forming process can be advantageously improved with a diverging wall thickness toward the screw axis.

In an embodiment, one or more material cross sections of one or more helical profiles of the helical arrangement, particularly the cross-sectional profile, the spiraling of which generates or defines the respective helical profile, respectively contain or intersect the screw axis. In other words, one or more helical profiles of the helical arrangement respectively may feature a core over sections (of the screw axis) or over their entire length and be defined or delimited by closed helicoids. In an embodiment, a primary forming process can thereby be advantageously improved.

Additionally or alternatively, one or more material cross sections of one or more helical profiles of the helical arrangement, particularly the cross-sectional profile, the spiraling of which generates or defines the respective helical profile, respectively do not contain or intersect the screw axis in an embodiment. In other words, one or more helical profiles of the helical arrangement respectively may feature no core over sections (of the screw axis or over their entire length or feature a rotationally symmetrical recess surrounding the screw axis and be defined or delimited by open helicoids. In an embodiment, the ratio between torsional rigidity and weight can thereby be advantageously improved.

In an embodiment, one or more helices of one or more helical profiles of the helical arrangement respectively include a constant or varying angle amounting to at least 1° , preferably at least 10°, particularly at least 30°, especially at least 40°, and/or no more than 89°, preferably no more than 80°, particularly no more than 60°, especially no more than 50°, with the screw axis, particularly over at least sections (of the screw axis). In an embodiment, the ratio between torsional rigidity and weight and/or the primary formability can thereby be improved .

In an embodiment, helices of two oppositely directed helical profiles include, in particular, identical angles with different sign or direction with the screw axis whereas helices of two equi-directional helical profiles include angles with the same sign or direction, particularly the same angles, with the screw axis in an embodiment.

In an embodiment, the primary formed part features one or more outer walls, particularly parallel to the screw axis, wherein one or more helical profiles of the helical structure respectively are integrally connected to or transform into said outer walls from the inside of the primary formed part. In an embodiment, the flexural strength of the formed part or component can thereby be advantageously increased. In an enhancement, one or more of these walls are at least essentially plane and/or extend in the direction of the screw axis over the entire length of the helical structure or only part thereof In an embodiment, two of these walls extend parallel to one another. The primary formability can thereby be advantageously improved in an embodiment. A cross-sectional profile, the spiraling of which generates or defines a helical profile, may be correspondingly shortened in the region of a wall, to which the helical profile is connected or into which the helical profile transforms, or (virtually) penetrate therein.

In an embodiment, the primary formed part features a rib arrangement with one or more ribs that respectively include an angle amounting to at least 10°, particularly at least 25°, and/or no more than 80°, particularly more than 65°, with the screw axis. In an embodiment, the flexural strength of the formed part or component can thereby be advantageously increased. In an enhancement, one or more of these ribs are at least essentially plane. In an embodiment, the rib arrangement extends in the direction of the screw axis over the entire length of the helical structure or only part thereof. Two or more ribs of the rib arrangement intersect one another in an embodiment. Additionally or alternatively, one or more ribs of the rib arrangement are integrally connected to one or more of the walls.

In an embodiment, one or more of the walls and/or ribs have, in particular, the same maximum and/or minimum height as the helical structure in a direction extending perpendicular to the screw axis.

In an embodiment, a particularly compact component or formed part can thereby be made available and manufactured.

In an embodiment, one or more of the walls and/or ribs may additionally or alternatively have, in particular, a greater or smaller maximum and/or minimum height than the helical structure in a direction extending perpendicular to the screw axis.

In an embodiment, a particularly lightweight component or formed part can thereby be made available and manufactured and/or the helical structure can thereby be advantageously protected and shielded.

In an embodiment, the primary formed part is (realized) free of undercuts in a removal direction extending perpendicular to the screw axis. In an embodiment, a primary forming process can thereby be advantageously improved.

In an embodiment, the primary formed part may contain or, in particular, consist of plastic, In an enhancement, the plastic is fiber-reinforced, particularly reinforced with glass fibers or carbon fibers. The plastic may additionally or alternatively be expanded. In an embodiment, the plastic may contain or, in particular, consist of a thermoplastic polymer, especially polyethylene (PE), polypropylene (PP), polyvinyl chloride (PVC), polystyrene (PS), polyurethane (PU/PUR) or polyethylene terephthalate (PET) and/or a thermosetting polymer,

Additionally or alternatively, the primary formed part may contain or, in particular, consist of metal, especially steel. In an enhancement, the primary formed part may contain or, in particular, consist of a light metal alloy, especially an aluminum and/or magnesium alloy. The metal or the light metal alloy may be additionally or alternatively expanded.

In an embodiment, the primary formed part particularly features one or more rotationally symmetrical and/or threadless bearing surfaces, especially smooth bearing surfaces, for supporting components in a rotatable or rotationally movable fashion, particularly for the sliding support of a counter bearing surface or for the support of one or more rolling (bearing) bodies. In an embodiment, the threadless primary formed part accordingly is supported in a rotatable or rotationally movable fashion. For this purpose, the motor vehicle component arrangement features in one embodiment several sliding and/or rolling bearings, in which the primary formed part, particularly its bearing surfaces, are or can be supported in a rotationally movable fashion in an enhancement. One or more sliding and/or rolling bearings of the motor vehicle component arrangement may be connected to the primary formed part, particularly in a form-fitting, frictionally engaged and/or integral fashion. Accordingly, the primary formed part features in an embodiment one or more bearing surfaces for the arrangement, particularly the form-fitting, frictionally engaged and/or integral mounting_{;} of one or more sliding or rolling bearings.

In addition to the primary formed part, the motor vehicle component arrangement accordingly features in an embodiment of the present disclosure one or more sliding or rolling bearings, in which the primary formed part is rotatably supported, and/or two rotatably mounted shafts that can be connected, particularly are connected, to connecting flanges of the primary formed part, especially in a form-fitting, frictionally engaged and/or integral fashion.

In an embodiment, an operating torque serves for realizing a rotary actuation, particularly of a seat adjusting mechanism, For this purpose, the primary formed part features in an embodiment one or more lever arms that are spaced apart from one another, particularly in the direction of the screw axis, and/or rotationally offset around the screw axis, especially such that they lie opposite of one another, in order to manually apply or transmit operating torques around the screw axis.

In an embodiment, an operating torque particularly serves for transmitting a driving torque, especially of a drivetrain arrangement. For this purpose, the primary formed part features on its face one or more connecting flanges that, in particular, lie opposite of one another in the direction of the screw axis and in an embodiment serve for applying operating torques around the screw axis, especially for connecting two rotatably mounted shafts in a form-fitting, frictionally engaged and/or integral fashion.

### BRIEF DESCRIPTION OF THE DRAWINGS

The present disclosure will hereinafter be described in conjunction with the following drawing figures, wherein like numerals denote like elements.

FIG. 1 shows a perspective view of a release lever of a seat adjusting mechanism according to an embodiment of the present disclosure;

FIG. 2 shows a section along the line II-II in FIG. 1;

FIG. 3 shows a section along the line III-III in FIG. 1; and

FIG. 4 shows a top view of a section of the primary formed part.

### DETAILED DESCRIPTION

The following detailed description is merely exemplary in nature and is not intended to limit the invention or the application and uses of the invention, Furthermore, there is no intention to be bound by any theory presented in the preceding background of the invention or the following detailed description.

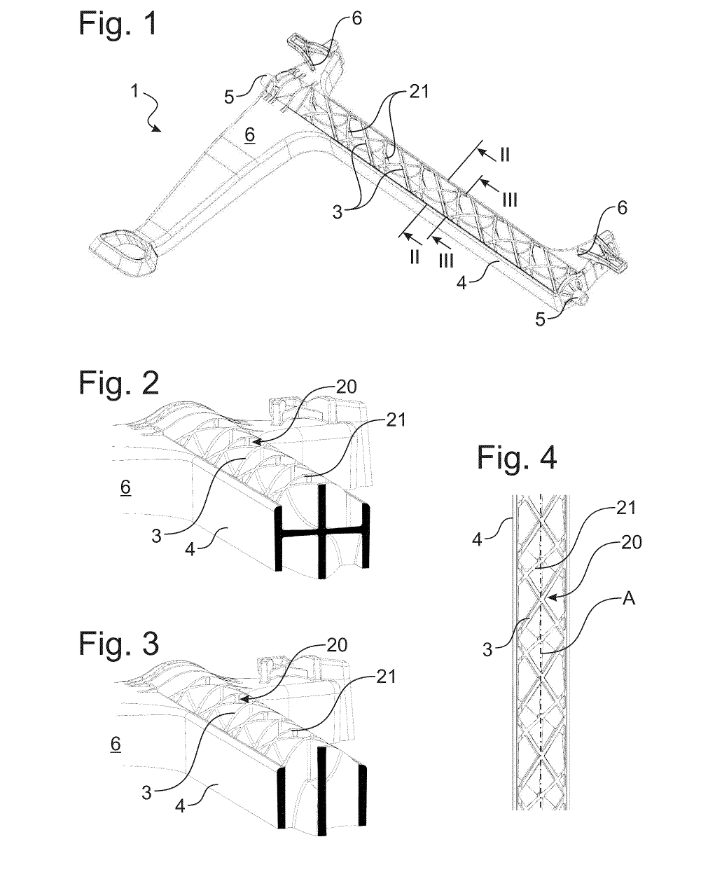

FIG. 1 shows a perspective view of a primary formed part according to an embodiment of the present disclosure in the form of a release lever 1 of a seat adjusting mechanism.

The primary formed part 1 has a helical structure with a helical profile 20, the surface of which features helices that spiral around a screw axis A, wherein an edge or guide curve of said helices is as an example identified by the reference symbol 21 in FIGS. 1-4, and wherein the helical profile 20 follows these helices.

In the exemplary embodiment, the primary formed part 1 is manufactured in the form of an injection-molded part with a slide-free mold that is opened in a removal direction perpendicular to the screw axis in a mold parting plane, in which the screw axis A lies perpendicular to the plane of projection of FIG. 4.

The helical profile 20 in the form of a screw or endless screw or spiral is mathematically generated or can be defined by spiraling a cross-sectional profile around the screw axis A. Accordingly, the surface of the helical profile 20 is defined by a multitude of helices spiraling around the screw axis A, wherein one helix is as an example identified by the reference symbol 21,

in the exemplary embodiment, the helix 21 of the helical profile 20 has a constant pitch or screw parameter.

In a modification, the double-threaded or multiple-threaded helical structure features two or more equi-directional helical profiles that are offset relative to one another in the direction of the screw axis and have the same spiraling direction.

In a likewise modification, the helical structure features two or more oppositely directed helical profiles that respectively have different or opposite spiraling directions.

In the exemplary embodiment, the cross-sectional profile of the helical profile 20, the spiraling of which generates or defines the helical profile 20, is realized rectangular and therefore features two straight, parallel sides that lie opposite of one another. In other words, the helical profile 20 is respectively defined or delimited by ruled helicoids on both sides.

In a modification, one or both sides of the cross-sectional profile may also be curved.

In the exemplary embodiment, the wall thickness of the helical profile 20 is constant toward the screw axis A.

In a modification, the wall thickness may converge or diverge toward the screw axis A.

In the exemplary embodiment, material cross sections of the helical profile 20, particularly the cross-sectional profile, respectively contain or intersect the screw axis A such that the helical profile 20 has a core and is defined or delimited by closed helicoids.

In a modification, the helical profile may feature no core over sections (of the screw axis) or over its entire length or feature a rotationally symmetrical recess surrounding the screw axis and be defined or delimited by open helicoids.

In the exemplary embodiment, the helix 21, in particular, includes a constant angle of approximately 45° with the screw axis A.

In the exemplary embodiment, the primary formed part I features two plane outer walls 4 that extend parallel to one another and to the screw axis A, wherein the helical profile 20 respectively is integrally connected to or transforms into said outer walls from the inside of the primary formed part. The cross-sectional profile generating this helical profile is correspondingly shortened in the region of the connection to the walls 4 or virtually penetrates therein.

In the exemplary embodiment, the primary formed part features a rib arrangement with several plane ribs 3 that include an angle of approximately 35° with the screw axis A. The ribs 3 intersect one another and the helical profile 20 and are integrally connected to one another and to this helical profile, as well as to the walls 4.

In the exemplary embodiment, the ribs 3 have the some maximum height as the helical profile 20 in a direction extending perpendicular to the screw axis A as illustrated, in particular, in FIGS. 2, 3.

The walls 4, in contrast, have a smaller maximum height than the helical profile 20 in this direction as likewise illustrated, in particular, in FIGS. 2, 3.

The primary formed part 1 is realized free of undercuts in the removal direction extending perpendicular to the screw axis A perpendicular to the plane of projection of FIG. 4.

The primary formed part I consists of plastic in the exemplary embodiment. It may likewise consist of metal.

In the exemplary embodiment, the primary formed part I features a rotatable sliding support in the form of two bearing surfaces 5, in which it is rotatably supported in sliding bearings of the seat adjusting mechanism. The seat adjusting mechanism features corresponding sliding bearings for this purpose.

In order to manually carry out a rotary actuation of the seat adjusting mechanism, the primary formed part 1 features in the exemplary embodiment several lever arms 6 that are spaced apart from one another in the direction of the screw axis and serve for applying operating torques around the screw axis A.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A primary formed part for transmitting operating torques comprising a helical structure featuring at least one helical profile with a helix that spirals around a screw axis.

17. The primary formed part according to claim 16, wherein the helical structure comprises at least two equi-directional helical profiles that are offset relative to one another in the axial direction and have the same spiraling direction.

18. The primary formed part according to claim 16, wherein the helical structure comprise at least two oppositely directed helical profiles with different spiraling directions.

19. The primary formed part according to claim 16, wherein the wall thickness of at least one helical profile of the helical structure is essentially constant with respect to the screw axis.

20. The primary formed part according to claim 16, wherein the wall thickness of at least one helical profile of the helical structure converges toward the screw axis.

21. The primary formed part according to claim 16, wherein the wall thickness of at least one helical profile of the helical structure diverges from the screw axis.

22. The primary formed part according to claim 16, wherein at least one material cross section of at least one helical profile includes the screw axis.

23. The primary formed part according to claim 16, wherein the helix of at least one helical profile includes an angle amounting to at least 1° and no more than 89° with the screw axis.

24. The primary formed part according to claim 23, wherein the helix of at least one helical profile includes an angle amounting to at least 30° and no more than 60° with the screw axis.

25. The primary formed part according to claim 16, further comprising at least one outer wall that particularly is plane, wherein the helical structure is connected to said outer wall from the inside of the primary formed part.

26. The primary formed part according to claim 16, further comprising a rib arrangement having at least one rib that particularly is plane and includes an angle in the range of 10° and no more than 80° with the screw axis.

27. The primary formed part according to claim 26, further comprising a rib arrangement having at least one rib that particularly is plane and includes an angle in the range of 25° and no more than 65° with the screw axis.

28. The primary formed part according to claim 16 which is free of undercuts in a removal direction extending perpendicular to the screw axis.

29. The primary formed part according to claim 16, further comprising fiber-reinforced and/or expanded plastic, particularly a thermoplastic polymer and/or a thermosetting polymer, and/or metal, especially a light metal alloy, that particularly is expanded.

30. The primary formed part according to claim 16, further comprising fiber-reinforced formed part.

31. The primary formed part according to claim 16, further comprising an expanded plastic formed part.

32. The primary formed part according to claim 16, further comprising an expanded light metal alloy part.

33. The primary formed part according to claim 16 further comprising at least one bearing surface in the form of a rotatable support on its face for manually applying operating torques around the screw axis.

34. The primary formed part according to claim 16 further comprising at least one bearing surface in the form of at least one lever arm for manually applying operating torques around the screw axis.

35. The primary formed part according to claim 16 further comprising at least one bearing surface in the form of at least one connecting flange on its face for manually applying operating torques around the screw axis.
